(19) United States
(12) Patent Application Publication
(10) Pub. No.: US 2017/0323305 A1
(43) Pub. Date: Nov. 9, 2017

(54) MECHANISM FOR SECURING LEGAL INTERACTIONS

(71) Applicant: Anantha PRADEEP, Piedmont, CA (US)

(72) Inventor: Anantha PRADEEP, Piedmont, CA (US)

(21) Appl. No.: 15/144,887

(22) Filed: May 3, 2016

(51) Int. Cl. G06Q 30/00; G06Q 50/18; G06Q 20/14

(52) U.S. Cl. CPC G06Q 30/018; G06Q 20/145; G06Q 50/18

(57) ABSTRACT

Provided are mechanisms and processes relating to securing legal interactions between a client and a legal professional. In one example, a process includes receiving a legal transaction request from a client, where the legal transaction request includes legal transaction parameters such as location and practice area. Legal professional profiles associated with legal professionals are then obtained, where the legal professional profiles include legal professional parameters such as level of experience and practice area. At least one legal professional is selected based on a comparison of the legal professional profiles and the legal transaction request. A legal services agreement is then generated by analyzing legal services agreements for prior legal transactions and determining vector space distances between these legal services agreements and the legal transaction parameters. The legal services agreement is transmitted to the client to secure a legal services arrangement between the client and a selected legal professional.

### TECHNICAL FIELD

The present disclosure relates to securing legal services with a legal professional. In one example, the present disclosure relates to mechanisms and processes for selecting a legal professional based on a legal transaction request provided by a prospective client and generating a legal services agreement between the prospective client and the selected legal professional.

### BACKGROUND

Individuals or businesses may come across the need to enlist the services of a legal professional for various matters. For instance, individuals may need a contract drafted, a will or trust drafted, or representation in a lawsuit that they are bringing or defending against. Of course, many other matters may also arise for individuals, including personal injury, financial matters, etc. Businesses may need one or more contracts drafted, assistance with forming a business entity, representation in a lawsuit they are bringing or defending against, etc.

Often, individuals and businesses seek recommendations for legal professionals by word of mouth or online reviews. However, these types of recommendations can be very general in nature and may not address a potential client's unique circumstances. Accordingly, these methods of finding recommendations may not provide a good fit for the client. For instance, a friend or colleague may recommend a trusted attorney that practices in general litigation for a large, pricey law firm that typically serves corporate clients. However, if the potential client is an individual seeking contract services, this may not be an appropriate match.

Consequently, improved mechanisms and processes for finding suitable legal professionals for a potential client are desirable. Furthermore, it would be desirable to facilitate the process of securing the services of a selected legal professional.

### SUMMARY

Provided are mechanisms and processes relating to securing legal interactions between a client and a legal professional.

In one aspect, which may include at least a portion of the subject matter of any of the preceding and/or following examples and aspects, a process includes receiving a legal transaction request from a client, where the legal transaction request includes legal transaction parameters such as location and practice area. Legal professional profiles associated with legal professionals are then obtained, where the legal professional profiles include legal professional parameters such as level of experience and practice area. At least one legal professional is selected based on a comparison of the legal professional parameters associated with the legal professional profiles and the legal transaction parameters associated with the legal transaction request. A legal services agreement is then generated by analyzing legal services agreements for prior legal transactions and determining vector space distances between these legal services agreements and the legal transaction parameters. The legal services agreement is transmitted to the client to secure a legal services arrangement between the client and a selected legal professional.

In another aspect, which may include at least a portion of the subject matter of any of the preceding and/or following examples and aspects, a system includes a legal services procurement processor and data storage. The legal services procurement processor is designed to receive a legal transaction request from a client, select at least one verified legal professional associated with a legal professional profile that has been verified for accuracy, and generate a legal services agreement corresponding to the legal transaction request. The legal transaction request includes legal transaction parameters such as location and practice area. The legal professional profile includes legal professional parameters such as level of experience and practice area. The legal services agreement is generated by analyzing legal services agreements for prior legal transactions and determining vector space distances between legal services agreements and the legal transaction parameters. The data storage for the legal services procurement system includes legal professional profiles, authenticity indexes, and legal services agreements. The legal professional profiles include legal professional parameters such as level of experience and practice area. The authenticity index for each legal professional profile represents a congruency between the legal professional profile and information provided by state bar association databases. The legal services agreements stored at the database include legal services agreements for prior legal transactions.

In yet another aspect, which may include at least a portion of the subject matter of any of the preceding and/or following examples and aspects, a computer readable medium includes computer code for receiving a legal transaction request from a client, where the legal transaction request includes legal transaction parameters such as location and practice area. The computer readable medium also includes code for obtaining legal professional profiles associated with legal professionals, where the legal professional profiles include legal professional parameters such as level of experience and practice area. The computer readable medium further includes code for selecting at least one legal professional based on a comparison of the legal professional parameters associated with the legal professional profiles and the legal transaction parameters associated with the legal transaction request. The computer readable medium also includes code for generating a legal services agreement by analyzing legal services agreements for prior legal transactions and determining vector space distances between these legal services agreements and the legal transaction parameters. The computer readable medium further includes code for transmitting the legal services agreement to the client to secure a legal services arrangement between the client and a selected legal professional.

These and other embodiments are described further below with reference to the figures.

### BRIEF DESCRIPTION OF THE DRAWINGS

FIG. 1 illustrates one example of a process for securing legal services.

FIG. 2 illustrates one example of a process for verifying the accuracy of a legal professional profile.

FIG. 3 illustrates one example of a process for generating a legal services agreement.

FIG. 4 illustrates one example of a legal services procurement system.

FIG. 5 illustrates one example showing particular aspects of a legal services procurement system.

### DETAILED DESCRIPTION OF EXAMPLE EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Typically, individuals and businesses seek recommendations for legal professionals by word of mouth or online reviews. However, these types of recommendations can be very general in nature and may not address a potential client's unique circumstances. Accordingly, using these methods of finding recommendations may not provide a good fit for the client. Consequently, the present disclosure describes improved mechanisms and processes for allowing a potential client to secure the services of a legal professional. In various embodiments, processes and mechanisms may include selecting a suitable legal professional based on the client's expressed needs. In some examples, these processes and mechanisms also include verifying the accuracy of professional profiles associated with legal professionals selected by the system. Furthermore, some processes and mechanisms include generating a legal services agreement that allow the client to secure the legal services of a particular legal professional. In addition, various processes and mechanisms provide infrastructure to facilitate obtaining a retainer from the client and releasing the retainer to the legal professional upon completion of legal services.

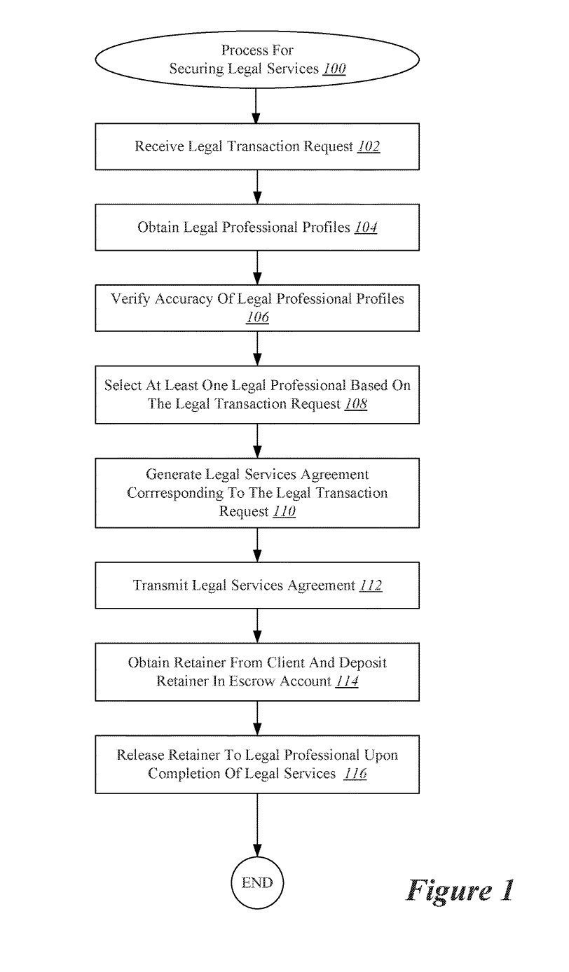

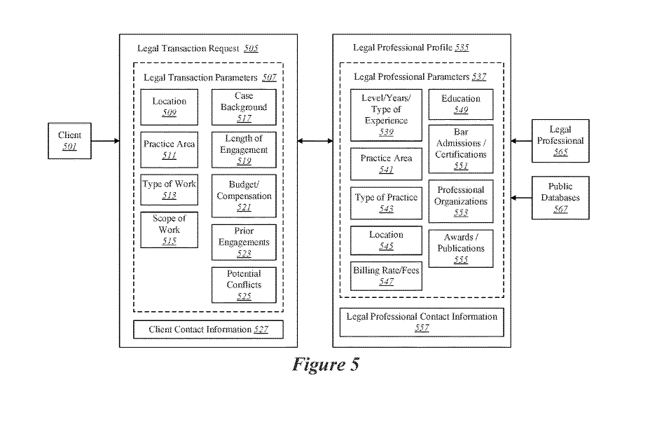

With reference to FIG. 1, shown is one example of a process for securing legal services. In this example, a legal transaction request is received by a legal services procurement system at 102. This legal transaction request is submitted by a client seeking services from a legal professional. As described more fully below with regard to FIG. 5, a legal transaction request includes legal transaction parameters that include information such as desired location, practice area, case background, budget, etc.

According to various embodiments, the system then obtains access to numerous legal professional profiles at 104. These legal professional profiles can be obtained in various ways. For instance, legal professionals may submit professional profiles to be included in the system and may be active participants in the system. In another example, information about legal professionals may be gathered from public sources such as state bar websites, law firm websites, etc. These legal professional profiles can include various legal professional parameters, as described in more detail with regard to FIG. 5. Some examples of legal professional parameters include information such as level of experience and practice area.

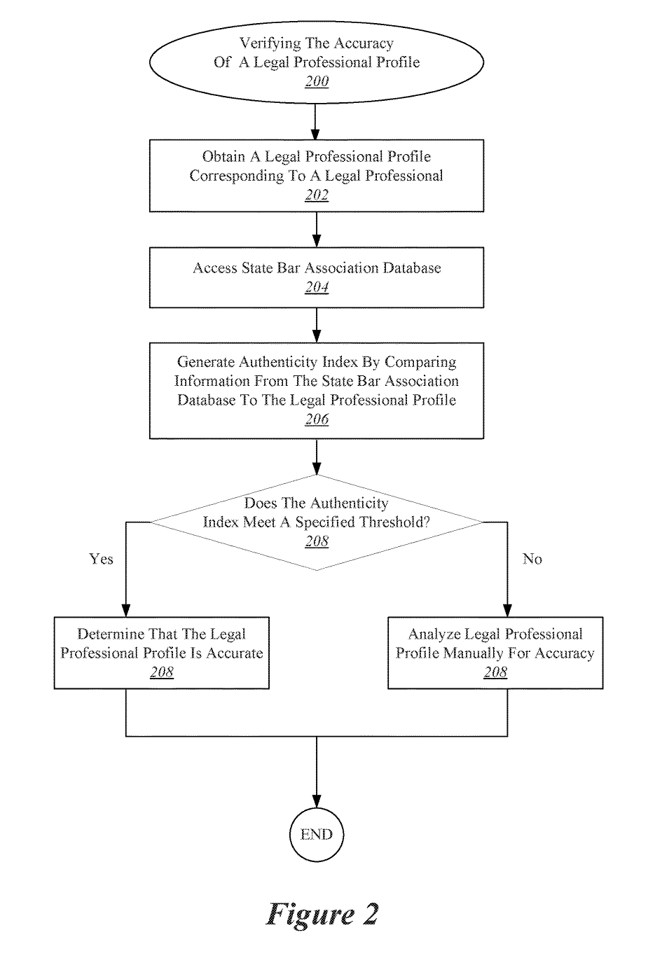

Next, the accuracy of each of the legal professional profiles is verified at 106. As described in more detail with regard to FIG. 2, each of the legal professional profiles can be evaluated by the system to confirm their accuracy. In some examples, verifying the accuracy of the legal professional profiles can be performed before selecting a legal professional for the client, as shown in the present example. This allows the system to search through only verified profiles. Alternatively, one or more legal professionals can be selected first and then their corresponding legal professional profiles can be verified before presenting these legal professionals to the client. The latter allows improved efficiency in some embodiments because fewer profiles can be checked during each search. Yet another alternative includes performing periodic verifications of the legal professional profiles included in the system's database, such that the verifications do not need to be performed for each client's legal transaction request.

In the present example, at least one legal professional is selected at 108 based on the legal transaction request submitted by the client. In particular, as described below with regard to FIG. 5, various legal transaction parameters are compared with various legal professional parameters to determine which, if any, legal professionals may be a good match for the type of legal services that the client is seeking. As mentioned previously, the legal professional profiles are verified by the system at some point before a legal professional is presented to a client. Accordingly, the legal professional selected is either chosen from a set of verified legal professional profiles or a selected legal professional profile is then verified after the legal professional is selected.

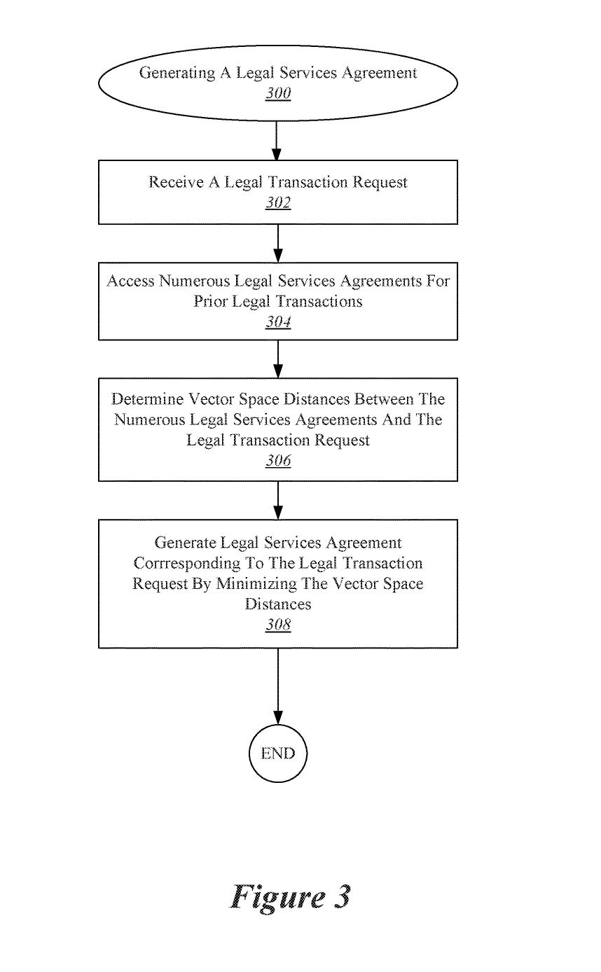

Once the one or more legal professionals are selected, a legal services agreement corresponding to the parameters specified in the legal transaction request is generated at 110. For instance, the legal services agreement can specify the parties to the contract (i.e. the client and a selected legal professional), the scope and extent of the services to be provided by the legal professional, and the terms of the compensation. One example of a process for generating a legal services agreement is described in more detail with regard to FIG. 3. Once the legal services agreement is generated, it can be transmitted to the client and the legal professional at 112. If multiple legal professionals are selected by the system, various options are possible. In particular, the system can prompt the client to choose one of the legal professionals from the list of suggested legal professionals, and then a legal services agreement can be generated for this particular professional and submitted to both parties. In another example, legal services agreements can be generated for each of the recommended legal professionals and the client can then select which to sign. The legal professional selected can then be sent a copy of the legal services agreement to sign as well. Once the legal services agreement is signed, then the legal services arrangement between the client and the verified legal professional is secured.

According to various embodiments, if the client and legal professional both sign the legal services agreement, then a retainer may be obtained from the client and deposited in an escrow account at 114. In some examples, this escrow account can be maintained by the legal services procurement system as a service to the legal professional and client. Once the legal services have been completed, then the retainer can be released to the legal professional at 116.

Although the present example is shown as a complete process with numerous steps, various steps can be performed separately in some embodiments. For instance, as discussed previously, the accuracy of legal professional profiles can be performed periodically instead of in response to each legal transaction request. Additionally, obtaining and releasing the retainer can be performed in a separate process or not at all in some examples. Accordingly, a subset of the steps shown can be included in the process without deviating from the scope of this disclosure.

With reference to FIG. 2, shown is one example of a process for verifying the accuracy of a legal professional profile. As described above with regard to FIG. 1, the legal services procurement system can recommend one or more legal professionals to a client based on a legal transaction request submitted by the client. The legal professionals can be “verified” by having their legal professional profiles verified for accuracy by the legal services procurement system.

In the present example, the process begins with obtaining a legal professional profile that corresponds to a legal professional at 202. As described above with regard to FIG. 1, this verification process can be performed periodically by the system to “verify” the legal professional profiles stored by the system or as a verification of a particular practitioner or practitioners in response to a legal transaction request submitted by a client.

Next, the system accesses a state bar association database at 204. This database can be accessed through an attorney search webpage for a state bar, or the like. In some examples, other types of public databases or information can be used in place of or in addition to the state bar association databases or websites. For instance, court records, alumni databases, etc. can also be used in some embodiments.

In the present example, an authenticity index is generated by comparing information from the state bar association database to information in the legal professional profile at 206. For instance, an authenticity index can be generated with a score that ranges from 1 to 10. For complete accuracy between the state bar association database information and legal professional profile information, the authenticity index is assigned a 10 and for complete inaccuracy, the authenticity index is assigned a 1. If the authenticity index falls below a certain threshold, then the legal professional profile can be flagged for inaccuracy. If the authenticity index meets or exceeds a certain threshold, then the legal professional profile is deemed verified. Although a specific scale is described in this example as between 1 to 10 for the authenticity index, it should be recognized that any scale can be used, such as 0 to 1, 1-100, etc.

Once the authenticity index is generated, a determination is made whether the authenticity index meets a specified threshold at 208. In the present example, a specified threshold can be set at 10. Accordingly, if the authenticity index is 10, then it meets the specified threshold. In this situation, a determination can then be made that the legal professional profile is accurate at 208. However, if the authenticity index falls below the specified threshold of 10, then the legal professional profile can be flagged for manual analysis at 208. For instance, flagged profiles can be assigned to be vetted by an individual that can check various aspects of the profile for accuracy. Although the specified threshold described in the present example is set at 10, other thresholds can be specified depending on the situation. For instance, an authenticity index of 9 may represent that there were discrepancies between the state bar association database information and legal professional profile information that can be fixed automatically by the system to bring the legal professional profile up to an authenticity index of 10. In this case, an additional step may be included that includes updating the legal professional profile until it has an authenticity index of 10. Furthermore, in this case, manual analysis of a legal professional profile may only be appropriate for situations in which the system cannot automatically update the legal professional profile automatically.

With reference to FIG. 3, shown is one example of a process for generating a legal services agreement. As described above with regard to FIG. 1, a legal services agreement is generated based on the parameters specified in a legal transaction request submitted by a client. In particular, a legal transaction request may specify parameters such as preferred location, practice area, and budget/fee structure. The legal transaction request may also specify parameters providing information about the legal matter such as type of work, scope of work, case background, and length of engagement. Additionally, information about prior engagements, potential conflicts, or the like, may be included in the parameters. Of course, various other parameters may also be included in some implementations.

According to various embodiments, a legal services agreement sets forth the agreed upon terms and expectations of the client and a selected legal professional. For instance, the legal services agreement may specify the parties to the contract (i.e. the client and a selected legal professional), the scope and extent of the services to be provided by the legal professional, the terms of the compensation, governing law, etc. The legal services agreement can be generated based on the parameters specified in the legal transaction request and existing legal services agreements.

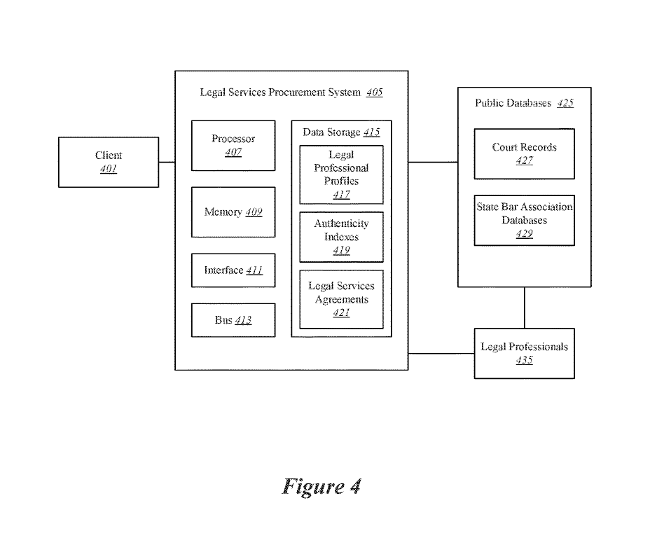

According to various embodiments, a legal transaction request is received at 302. Specifically, a legal transaction request is submitted by a client seeking to secure the services of a legal professional. Next, numerous legal services agreements are accessed. These legal services agreements can be from prior legal transactions, example/sample documents, forms, etc. These legal services agreements can be stored by the legal services procurement system, as shown in FIG. 4, or at another location that is accessible by the system.

In the present example, the legal services agreements are analyzed by determining vector space distances between the legal transaction request and the numerous legal services agreements stored by the legal services procurement system at 306. In particular, vector space models can be used to represent the legal transaction request and the existing legal services agreements. Specifically, the legal transaction request can be represented as a vector with each of the legal transaction parameters corresponding to a dimension in the vector: r=(w_{1,r}, w_{2,r}, . . . w_{n,r}), where r is the legal transaction request and each w is a different legal transaction parameter. Each of the existing agreements can be represented as a vector with various terms specified in the agreements corresponding to dimensions in the vector: aⱼ=(w_{1,j}, w_{2,j}, . . . w_{n,j}), where a is an existing legal services agreement and each w is a different term in the document. According to various embodiments, vector operations can be used to compare the specified legal transaction parameters with numerous existing documents. Furthermore, these vector operations can be used to determine which existing services agreements are the closest matches.

According to various embodiments, the vector space distances represent how closely the legal transaction request matches the numerous existing legal services agreements. Thus, finding the legal services agreements with the lowest vector space distances from the legal transaction request also means finding the legal services agreements that would be most appropriate to use to secure legal services for the client with a specified legal professional based on the parameters specified in the legal transaction request.

In the present example, a legal services agreement is generated by selecting an existing legal services agreement that has the lowest or one of the lowest available vector space distances from the legal transaction request at 308. In some instances, the selected legal services agreement can be used as-is, with changes made to the names of the parties (i.e. name of client and selected legal professional), especially when the vector space distance is close to zero. In other instances, the selected legal services agreement can be tailored to match the specifications of the parameters of the legal transaction request. These changes can be made automatically by the system, the selected legal professional, the client, or by other means, depending on the application.

With reference to FIG. 4, shown is one example of a legal services procurement system that can be used to implement various examples described in the present disclosure. In particular, the legal services procurement system 405 is used to assist a client 401 with finding and securing the services of a legal professional 435 that can provide the legal services described by the client in a legal transaction request. The legal services procurement system 405 can be used to perform various actions, such as verifying the accuracy of legal professional profiles, recommending legal professionals that may provide appropriate services for the submitted legal transaction request, generating a legal services agreement, and the like. In some instances, the legal services procurement system 405 can be used to implement a computing device, such as a mobile device, computer, laptop, etc.

In the present example, the legal services procurement system 405 includes a processor 407, memory 409, interface 411, bus 413, and data storage 415. According to various embodiments, when acting under the control of appropriate software or firmware, the processor 407 is responsible for such tasks such as optimization. Various specially configured devices can also be used in place of a processor 407 or in addition to processor 407. The complete implementation can also be done in custom hardware. In addition, processor 407 can carry out various tasks relating to verifying the accuracy of legal professional profiles, recommending legal professionals, generating legal services agreements, etc.

In particular example embodiments, the system 405 uses memory 409 to store data and program instructions and maintain a local side cache. The program instructions may control the operation of an operating system and/or one or more applications, for example. The memory or memories may also be configured to store received metadata and batch requested metadata.

According to various embodiments, the interface 411 may include separate input and output interfaces, or may be a unified interface supporting both operations. The interface 411 is typically configured to send and receive data packets or data segments over a network. For instance, the interface 411 can send and receive data packets to and from clients 401, public databases 425, and legal professionals 435. Particular examples of interfaces the device supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces, and the like. Generally, these interfaces may include ports appropriate for communication with the appropriate media. In some cases, they may also include an independent processor and, in some instances, volatile RAM. The independent processors may control such communications intensive tasks as packet switching, media control, and management. Additionally, bus 113 can include a PCI bus, or the like.

In the present example, data storage 415 is used to store information such as legal professional profiles 417, authenticity indexes 419, and legal services agreements 421. The legal professional profiles 417 can be provided by the legal professionals 435 in some cases, and can be extracted from public databases 425, law firm websites, and the like, in other cases. The authenticity indexes 419 are generated by the legal services procurement system 405 and stored at data storage 415. In addition, legal services agreements 421 can be stored at data storage 415 or in a location accessible to the system. The legal services agreements 421 include various legal services agreements such as those generated by the system 405, forms, example agreements, and the like. In some examples, forms and example agreements may be input or uploaded during initial setup or as the need arises.

As shown, the legal services procurement system 405 interacts with various entities such as clients 401, public databases 425, and legal professionals 435. Of course, other entities can also be included within the scope of this disclosure. In some examples, clients 401 can access the legal services procurement system 405 through the use of a mobile application (via a mobile device, tablet, computer, etc.) or through a portal to the system 405. The public databases 425 can include court records 427, state bar association databases 429, and the like. Furthermore, law firm websites, law school alumni websites, and other sources can be accessed by the system 405 as public databases 425, such as for verifying legal professional profiles 417 associated with legal professionals 435. In addition, the legal services procurement system 405 also interacts with legal professionals 435. Specifically, legal professionals 435 can sign up with the system and provide their legal professional profiles and any other relevant information, in some instances. Moreover, the system interacts with legal professionals 435 such as by providing a legal services agreement when a client is found for a legal professional, or by providing services related to handling retainers obtained from clients 401.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

With reference to FIG. 5, shown is one example illustrating particular aspects of a legal services procurement system. As described in various examples, a client 501 submits a legal transaction request 505 that includes legal transaction parameters 507 that provide details about the legal services that the client is seeking. Based on the legal transaction request 505 submitted, a legal professional 565 is chosen based on a corresponding legal professional profile 535.

In the present example, a legal transaction request 505 includes numerous legal transaction parameters 507 such as a location 509, practice area 511, type of work 513, scope of work 515, case background 517, length of engagement 519, budget/compensation 521, prior engagements 523, and potential conflicts 525. Of course, a subset of these parameters can be used in some implementations, and additional parameters can also be included in some examples.

According to various embodiments, the location 509 indicates a preferred location such as location of the legal professional 565, location of the client 501, location of the venue (e.g. court or other proceedings). The practice area 511 indicates the area of law for which the client 501 is seeking representation. For instance, the practice area 511 may be employment law, immigration law, patent law, estates and trusts, tax law, etc. The type of work 513 specifies aspects such as whether the work product will be drafting a contract, providing counseling, providing litigation representation, etc. Additionally, the type of work can specify whether the case is a civil or criminal case, whether it is plaintiff side, defendant side, or class action, etc. The scope of work 515 includes aspects such as whether the representation sought is for a particular discrete matter, ongoing representation, etc., including the size of the matter.

In the present example, the case background 517 includes a description of the matter, such as the parties involved, the facts of the case, and what has happened so far. The length of engagement 519 indicates how long the client 501 wishes to retain the services of the legal professional 565. The budget/compensation 521 indicates how much the client 501 is looking to spend on the legal services, and may include a flat rate, hourly rate, or other requested structure. Prior engagements 523 include other legal professionals that the client 501 has worked with and timeframes for these representations. Potential conflicts 525 include other individuals or entities that may pose a conflict of interest if the selected legal professional 565 is currently representing or has previously represented one of these individuals or entities.

According to particular embodiments, a legal transaction request 505 also includes client contact information 527. Client contact information 527 includes data such as email address, phone number, mailing address, etc. associated with the client 501. This information can be used by the system to communicate with the client 501. In some examples, this client contact information 527 is shared with the legal professional 565 sometime during the process such as when the legal services agreement is completed.

In the present example, a legal professional 565 is chosen by the system based on a corresponding legal professional profile 535. The legal professional profile 535 includes numerous legal professional parameters 537, such as level/years/type of experience 539, practice area 541, type of practice 543, location 545, billing rate/fees 547, education 549, bar admissions/certifications 551, professional organizations 553, and awards/publications 555. Of course, a subset of these parameters can be used in some implementations, and additional parameters can also be included in some examples.

According to various embodiments, the level/years/type of experience 539 includes information such as number of years in practice, current level/title (e.g. associate, partner, of counsel, etc.), and type of experience (e.g. small firm, mid-size firm, large firm, government, military, etc.). The information may also include the length of time practicing in different fields of law. The practice area 541 includes the area of law for which the legal professional 565 currently provides representation. For instance, the practice area 541 may be employment law, immigration law, patent law, estates and trusts, tax law, etc. In addition, the practice area 541 may include one or more areas of expertise. An area of expertise may be determined by experience in a field and/or certifications in a particular practice area. For example, a legal certification in admiralty law or as a patent attorney may provide specific areas of expertise. The type of practice 543 includes aspects such as the type of work done (contracts, counseling, litigation, etc.) and/or the structure of the practice, such as a solo practitioner, an attorney at a law firm, etc. The location 545 includes the location of the legal professional 565 and may also include the distance that legal professional is willing to travel. In addition, the billing rate/fees 547 includes information about the legal professional's hourly rates (i.e. rates for particular services), flat fees, retainers, fee structures, contingencies, etc.

In the present example, education 549 includes aspects such as undergraduate college and law school attended, and any other educational degrees. Additional information such as graduation dates and any awards may also be included. Bar admissions/certifications 551 includes information such as state bar admissions, dates of admission, professional certifications, patent bar admissions, etc. Professional organizations 553 include information about membership or other participation in specific groups or organizations. Additionally, awards/publications 555 include information about awards received by the legal professional 565 from schools attended, professional organizations, etc. and publications by the legal professional such as articles published in scholarly journals or other periodicals.

According to particular embodiments, a legal professional profile 535 also includes legal professional contact information 557. Legal professional contact information 557 includes data such as email address, phone number, mailing address, etc. associated with the legal professional 565. This information can be used by the system to communicate with the legal professional 565. In some examples, this legal professional contact information 557 is shared with the client 501 sometime during the process such as when the legal services agreement is completed.

As described in previous examples, some or all of the information included in a legal professional profile 535 may be obtained from public databases 567. For instance, these public databases 567 may include state bar association directories, law school alumni pages, public records, etc. Although law firm biographies may be used for some of the information, this information may need to be verified against other official records or databases. In some examples, the legal professional 565 may provide the information included in the legal professional profile 535.

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the true spirit and scope of the present invention. Moreover, although particular features have been described as part of each example, any combination of these features or additions of other features are intended to be included within the scope of this disclosure. Accordingly, the embodiments described herein are to be considered as illustrative and not restrictive.

What is claimed is:

1. A method comprising:
receiving a legal transaction request from a client, the legal transaction request including a plurality of legal transaction parameters including location and practice area;
obtaining a plurality of legal professional profiles associated with a plurality of legal professionals, the plurality of legal professional profiles including a plurality of legal professional parameters including level of experience and practice area;
verifying the accuracy of the plurality of legal professional profiles by generating an authenticity index that represents a congruency between the plurality of legal professional profiles and information provided by a plurality of state bar association databases;
selecting at least one verified legal professional associated with the legal professional profiles that have been verified for accuracy based on the legal transaction request;
generating a legal services agreement corresponding to the legal transaction request, the legal services agreement generated by analyzing a plurality of legal services agreements for prior legal transactions corresponding to the legal transaction request and determining vector space distances between the plurality of legal services agreements and the legal transaction parameters; and
transmitting the legal services agreement to the client to secure a legal services arrangement between the client and the verified legal professional.

2. The method of claim 1, wherein the plurality of legal professional parameters include location, years in practice, type of experience, and areas of expertise.

3. The method of claim 1, wherein the plurality of legal professional parameters include practice area, type of practice, and billing rate.

4. The method of claim 1, wherein the plurality of legal transaction parameters include type of work, scope of work, budget, and location.

5. The method of claim 1, wherein the plurality of legal transaction parameters include prior engagements, case background, length of engagement, and potential conflicts.

6. The method of claim 1, wherein legal professional profiles having an authenticity index falling below a specified threshold are analyzed manually.

7. The method of claim 1, wherein the legal services agreement is transmitted to the client and to the verified legal professional.

8. The method of claim 1, further comprising obtaining a retainer from the client and depositing the retainer into an escrow account for the legal services transaction.

9. The method of claim 8, wherein the retainer is released to the legal professional only upon completion of legal services outlined in the legal services agreement.

10. A system comprising:
a legal services procurement processor configured to receive a legal transaction request from a client, select at least one verified legal professional associated with a legal professional profile that has been verified for accuracy, and generate a legal services agreement corresponding to the legal transaction request,
wherein the legal transaction request includes a plurality of legal transaction parameters including location and practice area,
wherein the legal professional profile includes a plurality of legal professional parameters including level of experience and practice area,
wherein the legal services agreement is generated by analyzing a plurality of legal services agreements for prior legal transactions corresponding to the legal transaction request and determining vector space distances between the plurality of legal services agreements and the legal transaction parameters; and
data storage that includes legal professional profiles, authenticity indexes, and legal services agreements, wherein the legal professional profiles each include a plurality of legal professional parameters including level of experience and practice area, the authenticity indexes each represent a congruency between the plurality of legal professional profiles and information provided by a plurality of state bar association databases, and wherein the legal services agreements include legal services agreements for prior legal transactions.

11. The system of claim 10, wherein the plurality of legal professional parameters include location, years in practice, type of experience, and areas of expertise.

12. The system of claim 10, wherein the plurality of legal professional parameters include practice area, type of practice, and billing rate.

13. The system of claim 10, wherein the plurality of legal transaction parameters include type of work, scope of work, budget, and location.

14. The system of claim 10, wherein the plurality of legal transaction parameters include prior engagements, case background, length of engagement, and potential conflicts.

15. The system of claim 10, wherein legal professional profiles having an authenticity index falling below a specified threshold are analyzed manually.

16. The system of claim 10, further comprising an interface configured to transmit a legal services agreement to the client and to the verified legal professional.

17. The system of claim 10, further comprising an interface configured to obtain a retainer from the client and deposit the retainer into an escrow account for the legal services transaction.

18. The system of claim 17, wherein the retainer is released to the legal professional only upon completion of legal services outlined in the legal services agreement.

19. A computer readable medium comprising:
computer code for receiving a legal transaction request from a client, the legal transaction request including a plurality of legal transaction parameters including location and practice area;
computer code for obtaining a plurality of legal professional profiles associated with a plurality of legal professionals, the plurality of legal professional profiles each including a plurality of legal professional parameters including level of experience and practice area;
computer code for verifying the accuracy of the plurality of legal professional profiles by generating an authenticity index for each legal professional profile that represents a congruency between the legal professional profiles and information provided by one or more state bar association databases;
computer code for selecting at least one verified legal professional associated with the legal professional profiles that have been verified for accuracy based on the legal transaction request;
computer code for generating a legal services agreement corresponding to the legal transaction request, the legal services agreement generated by analyzing a plurality of legal services agreements for prior legal transactions corresponding to the legal transaction request and determining vector space distances between each of the plurality of legal services agreements and the legal transaction parameters; and
computer code for transmitting the legal services agreement to the client to secure a legal services arrangement between the client and the verified legal professional.

20. The computer readable medium of claim 19, further comprising computer code for obtaining a retainer from the client and depositing the retainer into an escrow account for the legal services transaction.
